(19) United States
(12) Patent Application Publication
(10) Pub. No.: US 2002/0069178 A1
(43) Pub. Date: Jun. 6, 2002

(54) Secure server system and method

(76) Inventor: Jeremy P. Hoffman, Freehold, NJ (US)

Correspondence Address: PENNIE AND EDMONDS, 1155 AVENUE OF THE AMERICAS, NEW YORK, NY, 100362711

(21) Appl. No.: 09/731,114

(22) Filed: Dec. 6, 2000

(51) Int. Cl. G06F 17/60

(52) U.S. Cl. 705/64

(57) ABSTRACT

A system and method for securely maintaining information while using the information to complete a transaction is disclosed. A user's fraud-sensitive data is stored on a first server that is unconnected to a public network. The user's information regarding a particular transaction is obtained by being input by the user through the public network and maintained on a storage device on a second server that is connected to the network. The information maintained on the storage device on the second server is transferred to the first server without electrically connecting the first server to the second server, and the user's information along with the fraud-sensitive data of the user is processed to determine order information, part of which is transmitted to the private receiving network via a nonpublic communications method to complete the particular transaction. The identification of the user may also be verified before the charging information is transmitted to the private receiving network. Also, the system and method may employ a third server and a second storage device to efficiently process the transaction while maintaining the security of fraud-sensitive data on the first server. The system and method of the present invention is preferably employed to facilitate the purchase of goods, and may also be employed to manage medical records.

### CROSS-REFERENCE TO RELATED APPLICATIONS

This application is a continuation-in-part of U.S. patent application entitled “Secure Server System and Method,” filed Nov. 28, 2000, Serial No. _ _ /_ _ _ _ , Pennie & Edmonds LLP Docket No. 10404-003-999, the contents of which are incorporated herein by reference in its entirety.

### TECHNICAL FIELD

This invention relates generally to information security systems and, more particularly, to systems for securely maintaining fraud-sensitive data that may be needed to complete a transaction over an insecure network.

### BACKGROUND OF THE INVENTION

Systems and methods for protecting fraud sensitive information involved in transactions taking place over public networks are known in the art. These systems and methods are particularly desired by consumers who are transmitting, or are having transmitted, information that is personally sensitive, such as credit card information. Some of the most commonly used techniques employ encryption technology (such as symmetric and asymmetric encryption algorithms). But, given enough time, these techniques may eventually be broken, in which case all past encrypted information is subject to theft.

Where purchasing over a public network such as the Internet is involved, a number of proprietary payment and transaction systems have been employed to provide security. For example, some systems allow transactions made over the Internet that require payment via credit cards to be made without transmission of the credit card information over the Internet. In one such secure payment system, provided by First Virtual Holdings, Inc., credit card information was registered over the telephone instead of over the Internet, so it would not be easily intercepted. Similarly, in a method described in U.S. Pat. No. 5,778,173 to Apte, when a consumer identified a purchase to be made over an open network such as the Internet, communication to a server through the open network was dropped, and the user would be reconnected to another server via a more secure communication line through which the user could transmit credit card information to facilitate the purchase. But even though these systems provided servers having barriers to entry by those that were unauthorized, they nonetheless could not fully prevent an industrious unauthorized user from electronically breaking the security system to gain access to the credit card information.

Accordingly, it is desirable to provide a system and method that overcomes the limitations of the systems and methods known in the art. It is also desirable to provide a system and method that provides the utmost security to fraud-sensitive data, such as credit card information, by not allowing an unauthorized user any opportunity to break into the server that contains the fraud-sensitive data. It is also desirable to provide a system and method that provides the utmost security to fraud-sensitive data during each system or method step that involves the fraud-sensitive data, such as when collecting fraud-sensitive data, storing fraud sensitive data, and executing a transaction involving the fraud-sensitive data. Moreover, it is desirable to provide a system that provides the utmost security to fraud-sensitive data while allowing the fraud-sensitive data to be employed in a transaction involving communication over an insecure, open network such as the Internet.

### SUMMARY OF THE INVENTION

The present invention is directed to a system and method for securely maintaining information while using the information to complete a transaction. One embodiment of the present invention comprises storing a user's fraud-sensitive data on a first server that is unconnected to a public network; obtaining the user's information regarding a particular transaction input by the user through the public network and maintaining the information on a storage device on a second server that is connected to the network; transferring the information maintained on the storage device on the second server to the first server without electrically connecting the first server to the second server; processing the user's information along with the fraud-sensitive data of the user to determine charging information; and transmitting the charging information to a private receiving network via a nonpublic communications method to complete the particular transaction.

In one embodiment, transferring information maintained on the storage device on the second server to the first server without electrically connecting the first server to the second server includes detaching the first storage device from the second system and attaching the first storage device to the first server.

In another embodiment, transferring information maintained on the storage device on the second server to the first server without electrically connecting the first server to the second server includes operating a physical switch to drop a connection between the second server and first storage device and make a connection between the first server and the first storage device.

In another embodiment, an identification of the user is verified before charging information is transmitted to the private receiving network.

### BRIEF DESCRIPTION OF THE DRAWINGS

The detailed description will be better understood in conjunction with the accompanying drawings, in which like reference characters represent like elements, as follows:

FIG. 1 is a block diagram of a preferred embodiment of a secure server system in accordance with the present invention;

FIG. 2 is a block diagram of the operation of a portion of one implementation of the secure server system of FIG. 1, in accordance with the present invention;

FIG. 3 is a block diagram of the operation of a portion of another implementation of the secure server system of FIG. 1, in accordance with the present invention;

FIG. 4 is a block diagram of a detailed example of the portion of the implementation of the secure server system of FIG. 3, in accordance with the present invention;

FIG. 5 is a block diagram of another preferred embodiment of a secure server system in accordance with the present invention; and

FIG. 6 is a block diagram of the operation of a portion of the secure server system of FIG. 5, in accordance with the present invention.

FIG. 7 is a block diagram of a secure server system employing interface servers that can communicate with user interfaces that have different parameters, in accordance with the present invention.

FIG. 8 is a block diagram of an advantageous embodiment of a portion of the secure server system in which only one of two storage devices ever connects to the secure server, in accordance with the present invention.

### DETAILED DESCRIPTION OF THE PREFERRED EMBODIMENTS

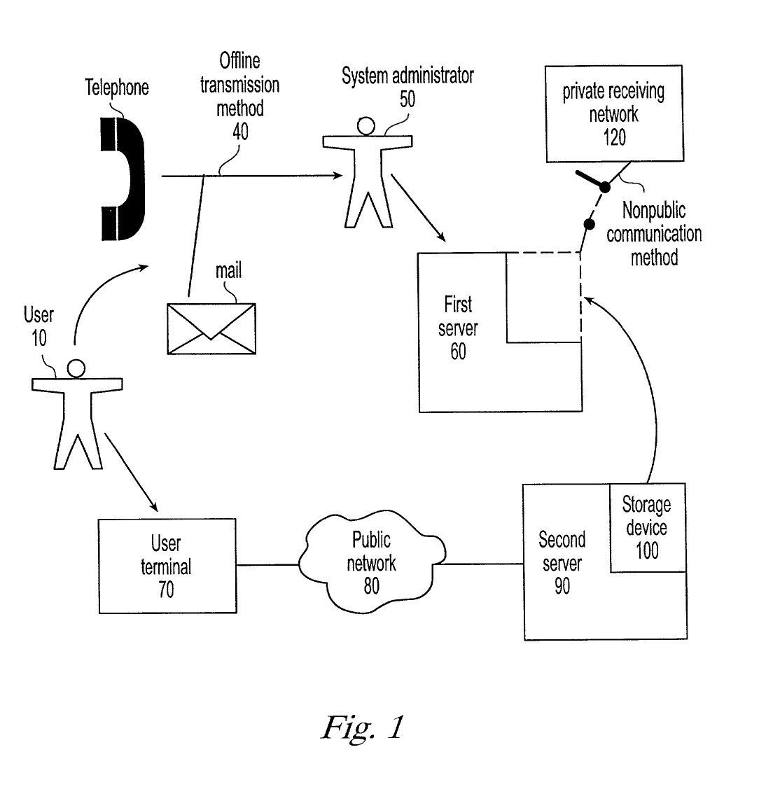

FIG. 1 depicts a preferred embodiment of the present invention. In this example, a user 10 registers his or her fraud-sensitive data using an offline transmission method 40. The fraud-sensitive data in this embodiment is payment information, such as a credit or bank card number and associated information necessary to charge goods or services on behalf of user 10. Also, the offline transmission method 40 in this embodiment is either a phone call or use of United States mail. The information is transmitted via the phone call or United States mail to a system administrator 50, who inputs and stores the information in first server 60, which is a computer or computerized system that is not connected to any public network, such as the Internet, and that contains and manages the fraud-sensitive information. First server 60 also generally includes a computer program created using conventional software and programming methods. In a specific implementation, user 10 registers his or her payment information by placing a telephone call to a specific customer service number that allows user 10 to speak to a system administrator, in this case a customer representative, and provide the customer representative with the payment information, including a credit card or bank card number and a billing address associated with the credit or bank card. Depending upon accepted standards for fraud protection, user 10 may only be able to have items shipped to the credit card billing address. The customer representative then enters the information into first server 60. Preferably, the system administrator 50 inputs and stores an arbitrary, unique identification number on both second server 90 and on first server 60. The identification number will better enable first server 60 to attach an order and any other useful, but not fraud-sensitive, information obtained from second server 90 to the correct set of fraud-sensitive data. The customer representative also communicates this number to user 10, such that user 10 may provide the number for identification when using the present invention. Preferably, after submitting the payment information, user 10 is informed that his or her payment information will never be sent over, or placed on, a public network such as the Internet.

First server 60 may be unconnected to any computer network, or may be connected only to computers through an intranet, or other private network, that is contained within a company or enterprise and does not include access to any public network such as the Internet. Thus, in accordance with an advantage of the present invention, first server 60 is able to maintain fraud-sensitive data with complete security such that a computer “cracker,” or someone who wants to break into first server 60 to access and misappropriate the fraud-sensitive data, cannot access the data.

Although offline transmission method 40, by which fraud-sensitive data is obtained, is preferably a phone call or use of United States mail, offline transmission method 40 may be another secure transmission method known in the art that does not involve transmission over a public network. Also, where offline transmission method 40 is a phone call or secure transmission method other than United States mail, the function of system administrator 50 can be replaced by an automated system that will automatically input and store the payment information transmitted by user 10, directly into first server 60.

Once the user 10 has transmitted his or her payment information, user 10 accesses and employs user terminal 70 to connect to second server 90 through public network 80, such as the Internet. User terminal 70 is generally a computerized device such as a desktop computer with a modem, or a mobile phone or other wireless computerized device with Internet access capability, able to connect to a public network. The connection between user terminal 70 and second server 90 may enable communication via one or more protocols and/or programming languages supported by terminal 70. For example, terminal 70 may communication with second server 90 by use of HTML (hypertext markup language), which many personal computers support for communication over public networks. Another example is the Wireless Application Protocol (WAP), which allows many portable devices such as personal digital assistants (PDAs) and mobile telephones to communicate over public network 80. The particular type or technology of user terminal employed is not critical to the present invention. Thus, any user terminal with the ability to connect to a public network may be employed.

Second server 90—a server that in this specific embodiment manages purchase orders by employing a common database management program capable of running on both second server 90 and first server 60—includes a first removable storage device 100. Second server 90 also generally includes a computer program created using conventional software and programming methods. In this embodiment, user 10 accesses a user interface, such as could be presented within a World Wide Web (WWW) site on second server 90. This interface may include branding and/or advertising or any other method or system that identifies and/or promotes the business objectives of the owner or manager of this embodiment of the invention. The user interface includes a shopping area that user 10 may browse to determine which, if any, products or services to purchase. When user 10 decides to purchase a product or service, such as by clicking a computerized figure of a purchase button or a hypertext link, or by another method known in the art of purchasing and sales using the Internet or public network interfaces, such as the widely used shopping cart model, the item is added to a queue, or purchase order, which is actively maintained by second server 90. The user can continue to shop within the shopping area, and may add purchases to the same purchase order. When user 10 indicates that he or she is finished shopping, the purchase order is presented to user 10 for verification. The purchase order is displayed to user 10 with all the products and services and quantities listed. User 10 may remove any product or service or adjust any quantities, or cancel the order. If user 10 is satisfied with his or her choices, user 10 approves the purchase order. At some point preceding or during the shopping process, or when user 10 initially selects a product or service to purchase, second server 90 determines whether user 10 registered his or her payment information with first server 60. This may be determined by comparing the identification information of users that were input to second server 90 and stored on removable storage device 100 after users originally registered with first server 60 with respect to a user interface user password, or by another method known in the art for determining whether a user browsing a particular user interface has a membership or other form of registration with the user interface. If user 10 is not registered, he or she is sent to a page that states that he or she is not registered and details the benefits of and instructions for registering. If the user is registered, the ordering process may continue.

In one embodiment of the present invention, the order is not processed until the identity of user 10 is confirmed. In a particular implementation of this embodiment, once the purchase order of a registered user 10 has been approved, the system displays a message to the user stating that the purchase order has been generated and will be e-mailed to user 10. User 10 is informed that the order cannot be processed until he or she replies to the e-mail to confirm his or her identity and commitment to purchase. Second server 90 then generates an e-mail that is sent to the registered user 10. This e-mail contains the purchase order and asks user 10 to reply to the e-mail to confirm that the order is committed to and was submitted to second server 90 and approved by user 10. Preferably, the user communicates his or her e-mail address to system administrator 50 when initially registering his or her fraud-sensitive data.

In another implementation of the embodiment, once the purchase order of a registered user 10 has been approved, a method involving public key encryption is employed to confirm the identity of user 10. Public key encryption generally includes the use of a public “key” to decode a sent message. Each qualified generator of an encoded message is issued a unique private key, which encrypts the message. The public key is readily available, allowing others to decrypt and read the encrypted message. But each private key attaches to the message an identifier that is unique to that private key. The result is a message that can be read by any user of the public network, but could only have been generated by the qualified holder of the private key. This technology allows a user 10 to be uniquely identified even though the private key is never sent over the network. This method may be employed in the present invention as follows: user 10 registers using offline transmission method 40, such as described above. Upon completion of registration, the first server 60 generates the private key that is unique to user 10. This private key is then sent to the user via an offline or other secure method, such by mailing a CD-ROM containing the private key. Upon receiving the private key, the user loads the key into user terminal 70. User 10 may then engage in the shopping and ordering process as described above. In this implementation, each order is encrypted with the private key of user 10 and transmitted over the public network, such as the Internet, to second server 90. Although it is noted that a user of the public network may be able to decrypt this message, and thus view the information transmitted by user 10 to second server 90, the information includes no fraud-sensitive information, and thus is not useful for misappropriation. But encrypting the information is useful for confirming the identity of the user 10 who transmitted it, since only user 10 could have generated the information encrypted with his or her private key.

The above-described methods of confirming the identity of user 10 are merely examples, and other methods and systems may be used to confirm the identity of user 10.

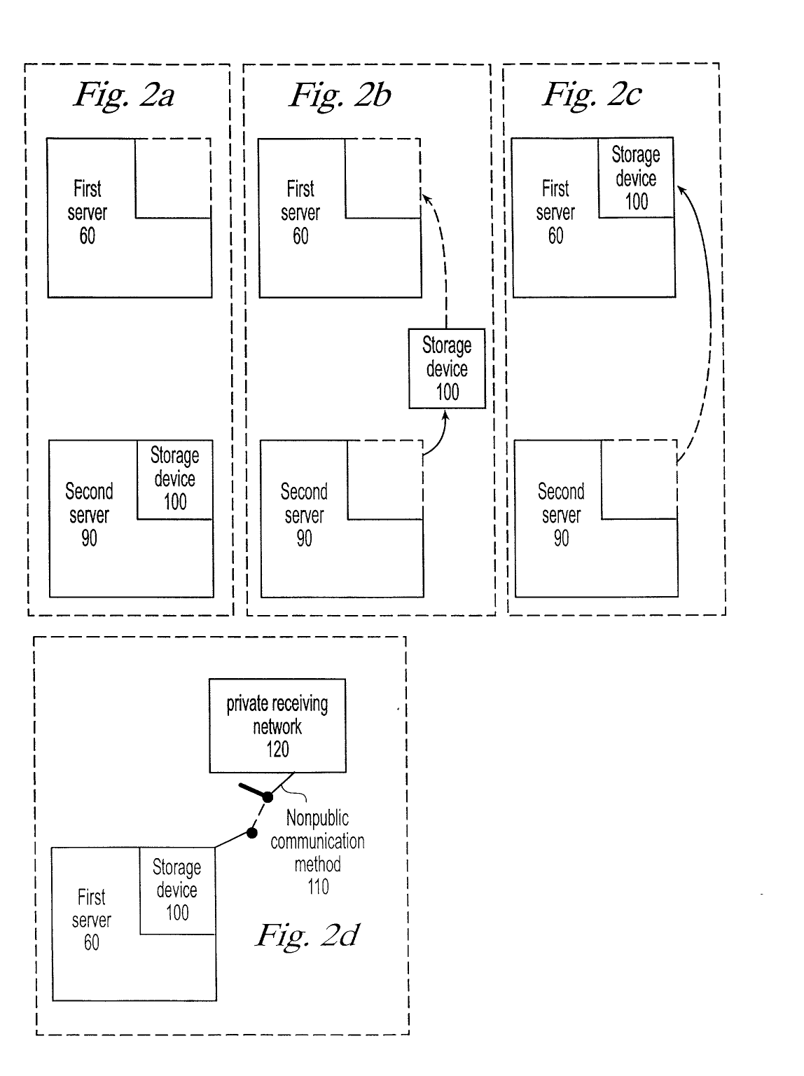

Referring to FIG. 2 along with FIG. 1, once user 10 has approved the order, or in the particular implementation described above, also confirmed the order via the exchange of e-mails, or through public key encryption, second server 90 employs a common database management program, capable of running on both second server 90 and first server 60, to process the information in organized form. Second server 90 then stores the user's information regarding a particular transaction, such as the identification of registered user 10 and the associated purchase information placed in organized form by the database management program, in first storage device 100. Then, the user's information maintained on the first storage device 100 on the second server 90 is transferred to the first server without electrically connecting the first server 60 to the second server 90. The first server is never accessible via second server 90, or through any user interface that is able to establish connection with second server 90 through a public or other connection. Thus, there is no risk that a computer “cracker” may access the fraud-sensitive data contained on first server 60 via connection to the second server 90.

In one embodiment, this transferring of the information includes detaching, or physically removing, the first storage device 100 from second server 90 and physically transferring it to first server 60, where it is attached to first server 60. Thus, first storage device 100 can never be connected to both first server 60 and second server 90 at the same time. In one implementation of this process, a person manually detaches the removable storage device 100, moves the first storage device 100 to first server 60, and manually attaches first storage device 100 in second server 90. The particular method of physical transfer of the first storage device 100 is not critical to the present invention.

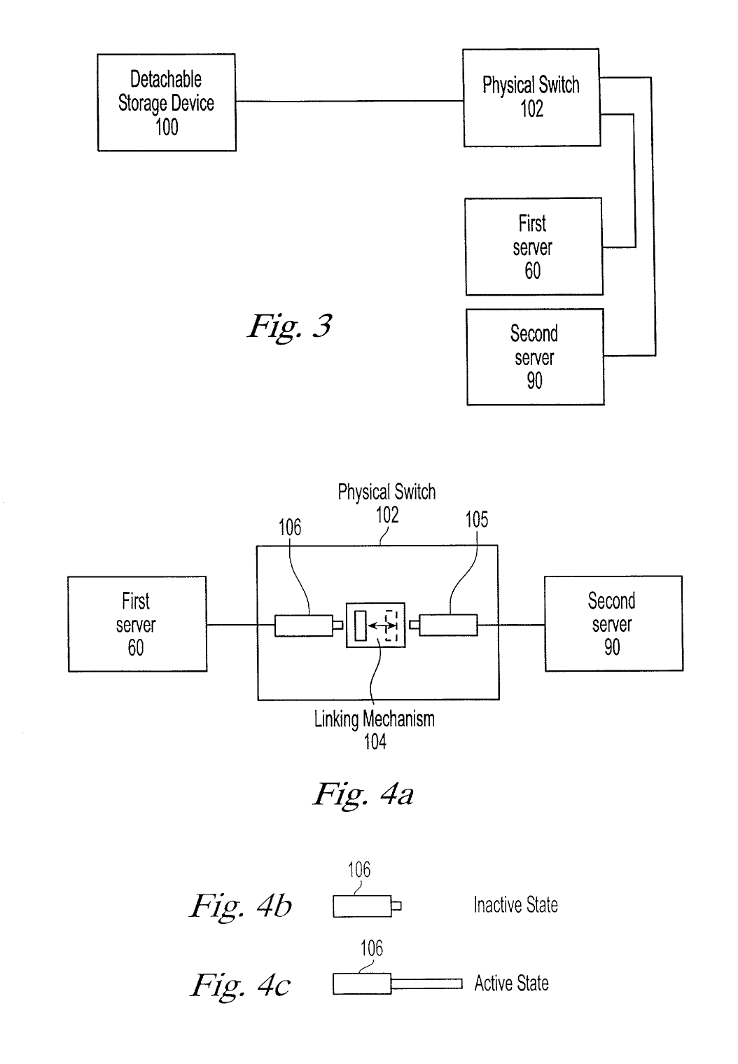

In another embodiment, transferring information includes operation of physical switch 102, as shown in FIG. 3. Physical switch 102 generally operates to provide a connection between either first server 60 and first storage device 100, or a connection between second server 90 and first storage device 100. But physical switch 102 is never operable to connect both first server 60 and second server 90 to first storage device 100 at the same time, and thus no user 10 will be able to access first server 60 via second server 90. In the specific implementation of physical switch 102 shown in FIG. 4, physical switch 102 includes linking mechanism 104, which may be moved to either of two positions. The “second” position provides a connection between second server 90 and first storage device 100, by providing a connection between electrical device 105, which is connected to second server 90, and first storage device 100. The “first” position provides a connection between first server 90 and first storage device 100, by providing a connection between electrical device 106, which is connected to first server 60, and first storage device 100. Thus, when linking mechanism 104 is moved from the second position to the first position, the connection between second server 90 and first storage device 100 is dropped, and a connection is made between first server 60 and first storage device 100. Thus, the user's information (originally input to second server 90) has been transferred to first server 60, which may now access the information for processing.

Physical switch 102 preferably connects to the servers through “hot-swappable” ports, as known in the art, to allow for safe disconnection and connection of first storage device 100. Thus, when linking mechanism 104 is moved from the second position to the first position, the user's information (originally input to second server 90) is transferred to first server 60, which may now access the information for processing. Preferably, software is also implemented in the present invention to provide “polling” of the automatic ports, as known in the art, to facilitate the hot-swap process.

Preferably, physical switch 102 operates automatically and electronically. In this implementation, at specified intervals, second server 90 closes the port to which first storage device 100 is connected. Second server 90 also sends a signal to electrical device 105 to which it is directly connected. The signal momentarily activates electrical device 106, which extends a mechanism (“active state” in FIG. 4) that moves linking mechanism 104 from the “second” position to the “first” position, disconnecting first storage device 100 from second server 90 and connecting first storage device 100 to first server 60. The electrical device 106 then immediately returns to its “inactive state.” The process of closing the port of second server 90, disconnecting first storage device 100 from second server 90 and connecting first storage device 100 to first server 60 can be completed with conventional software and programming. Server 60 uses the same polling technique as used with second server 90, and detects that first storage device 100 is now connected, and opens the port. The user information contained on first storage device 100 may now be processed by first server 60.

Once the user information contained on storage device 100 has been transferred to first server 60 by employing of the methods described above, first server 60 processes the information of user 10 as organized by the database management program along with the fraud-sensitive data that user 10 originally transmitted to first server 60. Preferably, first server 60 also employs the database management program to organize the fraud-sensitive data so that the information regarding the particular transaction of user 10 on first storage device 100 can be automatically matched and processed with the payment information of user 10 by the database management program, to determine order information, which includes charging information. Charging information is information formatted such that particular charges associated with particular purchases by user 10 are matched with the payment information of user 10. For example, charging information may be a dollar amount associated with a particular product ordered by user 10, along with the credit card number of user 10. Order information preferably includes the products or services and their quantities ordered, the name, billing address, shipping address, e-mail address, and telephone number, and desired shipping options. This information, except for fraud-sensitive data, is stored on removable storage device 100. The charging information is sent to private receiving network 120, in this case a network server of a credit card company, via a nonpublic communication method 110, which is preferably a secure communication method such as a point-to-point connection used to conduct banking transactions on ATMs (automatic teller machines).

Preferably, first server 60 is connected to private receiving network 120 only for a time necessary to transmit the charging information to private receiving network 120 and to receive information regarding the status of the order, such as confirmation from the credit card company that the credit card of user 10 may be charged, after checking, for example, that the credit card number is valid, that the credit card limit has not been reached, etc. The status of the order, which does not include fraud-sensitive information, is stored on first storage device 100 as part of the order information.

In another embodiment, the charging information is processed locally. In this embodiment, the system shares the physical resources of a settlement bank or other credit card processor, such that the transaction can be executed using a local method of secure transfer, such as a detachable storage device system or dedicated private connection.

At some time after that communication, the order information other than fraud-sensitive data, which is now contained on first storage device 100, is transferred back to second server 90. In the embodiment where the first storage device is physically transferred between servers, first storage device 100 is detached from first server 60 and physically moved back to second server 90, where it is reattached. In the embodiment involving physical switch 110, the same basic process used to transfer the user information from second server 90 to first server 60 is used to transfer the order information other than fraud-sensitive data from first server 60 to second server 90. Thus, the port on first server 60 is closed, allowing first storage device 100 to be safely disconnected from first server 60; first server 60 sends a signal to electrical device 106 to which it is directly connected; the signal momentarily activates electrical device 105, which extends a mechanism (“active state” in FIG. 4) that moves linking mechanism 104 from the “first” position to the “second” position, disconnecting first storage device 100 from first server 60 and connecting first storage device 100 to second server 90; and the electrical device 105 immediately returns to its “inactive state.” Second server 90 then uses the polling technique, and detects that first storage device 100 is connected, and opens the port. The order information other than fraud-sensitive data, contained on first storage device 100, may now be processed by second server 90.

At this point, second server 90 may communicate with user 10 through public network 80 to provide details of the status of the order, and/or execution of the purchase order. The entire process up to this point may be repeated once more purchase orders have been placed by user 10.

The above-described process is preferably employed with multiple users simply by allowing multiple users to register and make purchases such as described with respect to user 10 above. Thus, the orders of multiple users that have registered their fraud-sensitive data, as discussed above, are stored and aggregated on first storage device 100, which is “attached” (e.g. connected via either of the implementations described above) to second server 90. Second server 90 places approved purchase orders or, in the particular implementation described above, approved orders that were also confirmed via the exchange of e-mails, or by public key encryption, in a queue in first storage device 100. Periodically, at predetermined intervals, first storage device 100 transfers the approved purchase order information from second server 90 and attached to first server 60, using one of the methods described above. Preferably, an automated system transfers the purchase order information at regular intervals so that the execution of the purchase transactions can be rapidly completed. Then, as described above, first server 60 processes the information of each of the multiple users as organized by the database management program along with the fraud-sensitive data of the particular user to determine charging information for each of the multiple users. Then, first server 60 will connect to private receiving network 120 via a secure communication method, such as described above, and transmit the charging information of each of the multiple users to private receiving network 120, and receive information regarding the status of the order, as described above. After this step, the order information contained on first storage device 100 is transferred from first server 60 to second server 90 to complete the process, as described above.

In a particular embodiment of the process of transmitting the charging information to private receiving network 120, the charging information will include, for each user, an amount corresponding to the total amount of all user purchases plus shipping, minus a predetermined percentage retained by the owner or manager of a system or method in accordance with the present invention.

In the embodiment where charging information is processed locally, the charging information may be also determined by calculating the total amount of all user purchases plus shipping, minus a predetermined percentage retained by the owner or manager of a system or method in accordance with the present invention.

In another embodiment of the present invention, the shopping area included on the user interface provided by second server 90 is divided into categories. The categories may include, for example, books, music, prescriptions, and travel. One reputable online seller will be chosen for each category. Although each of the shopping categories will be branded to the online seller, the flow and design of each of the shopping areas will be consistent and will communicate to the user that the user will remain within the user interface while browsing any of the shopping areas. For example, the user may see product or service sales information that had been obtained by a user interface manager from the user interface of the online seller and then loaded onto the user interface of second server 90. In this embodiment, the online seller will be able to obtain information from second server 90 (i.e., user information other than the fraud-sensitive data) relevant to each user that has made a purchase of a product or service from the online seller. This will allow the online seller to contact the user if, for example, a product or service that the user ordered was out of stock, or if shipping was to be delayed, so that the particular situation could be resolved independently of the managers or owners of the secure server system and method of the present invention. Thus, the online seller will take responsibility for handling all product satisfaction agreements, warranties, etc. In the case of a product return or cancellation, the seller and the user will negotiate the return/cancellation directly, and the user will return the item, as directed, to the seller. When the seller receives the item and wishes to apply credit to the user, the appropriate funds are transferred from the seller to the user interface manager of the present invention (minus any restocking charges, etc.), and the seller will contact the user interface manager, such as by e-mail, to detail the purchase and return transaction.

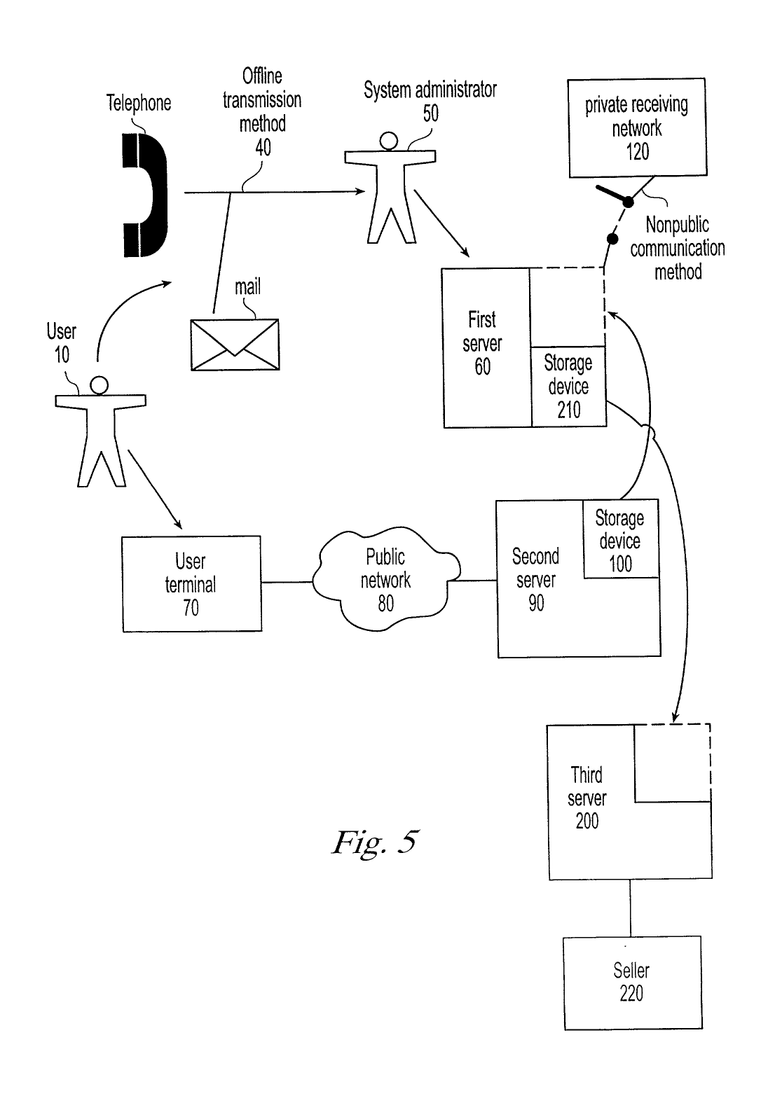

Referring to FIG. 5, another preferred embodiment of the present invention is shown, employing third server 200 and second storage device 210. In this embodiment, any of the systems and methods such as described with respect to FIGS. 1-4 may be implemented, except for the interaction between first server 60, second server 90, and first storage device 100. In this embodiment, after user 10 has registered, interacted with second server 90 through public network 80, approved a purchase order, and confirmed the order if applicable, second server 90 preferably employs a common database management program, capable of running on both second server 90, first server 60, and third server 200, to process the order information in organized form. Second server 90 stores the user's information regarding a particular transaction of user 10, such as the identification of registered user 10 and the associated purchase information placed in organized form by the database management program, in first storage device 100. Then, the user's information is transferred from second server 90, by either physical movement of first storage device 100 or via physical switch 110, as described above.

Once the user information from first storage device 100 has been transferred to first server 60, first server 60 processes the information of user 10 as organized by the database management program along with the fraud-sensitive data that user 10 originally transmitted to first server 60. Preferably, first server 60 also employs the database management program to organize the fraud-sensitive data so that the information of user 10 regarding the particular transaction on first storage device 100 can be automatically matched and processed with the payment information of user 10 by the database management program, to determine order information, including charging information, both of which are described above. First server 60 will also communicate with private receiving network 120 as described above and receive information regarding the status of the order, which will be included as part of the order information. First server 60 may also process the information locally, as described above. Selected portions of the order information are stored on second server 90, first storage device 100, and second removable storage device 210. For first storage device 100, the information stored includes order information regarding the status of the order. For second storage device 210, the information stored includes seller management information, which is the portion of the order information that would enable a seller to deliver the product or service to user 10, and contact user 10 if required. The seller management information preferably includes the products or services and their quantities ordered, the name, billing address, shipping address, e-mail address, telephone number, and desired shipping options of user 10. None of the information stored on first removable storage device 100 or second storage device 210 will include any fraud-sensitive data.

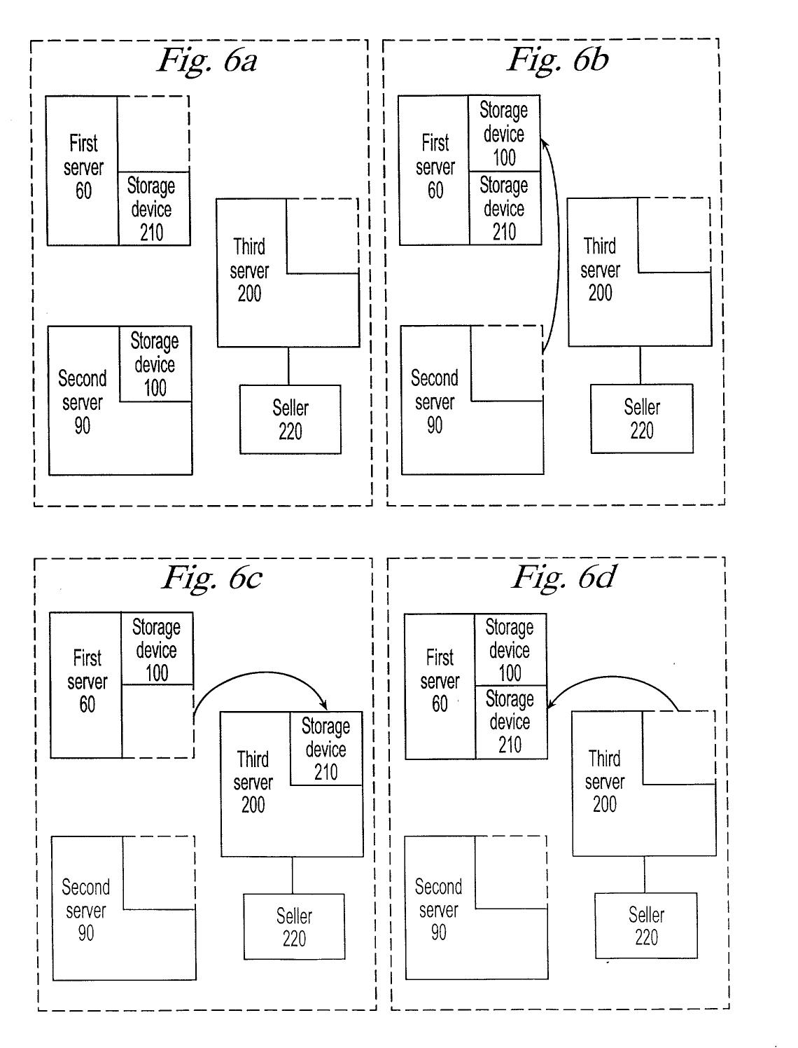

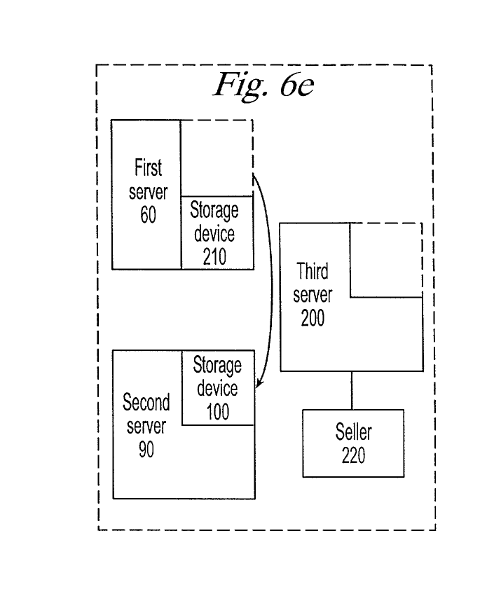

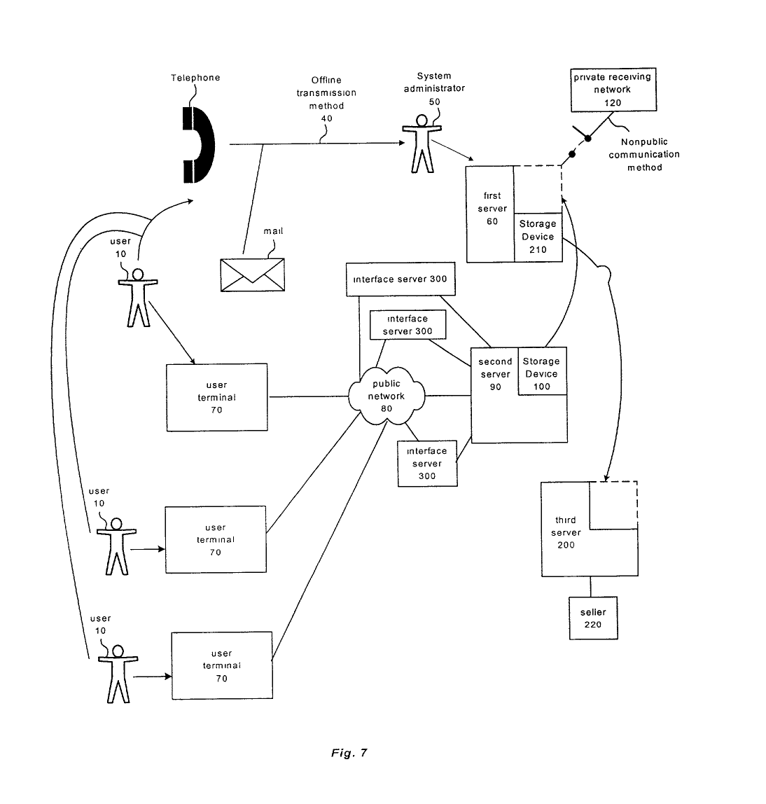

Referring to FIG. 6 along with FIG. 5, after the information, such as seller management information, is stored on second storage device 210, the information is transferred to third server 200. The transfer may include physically detaching second removable storage device 210 from first server 60, physically moving second removable storage device 210 to third server 200, and attaching it to third server 200. The transfer may also be completed via a physical switch, such as described above, that controls the connection of second removable storage device 210 to first server 60 and to third server 200. The information contained on second storage device 210 may then be sent to seller 220, through a communication connection, such as an Internet connection or other connection known in the art, by third server 200. The third server preferably processes the information on second storage device 210 using the database management program to determine appropriate electronic funds, such as funds that may be wired from a corporate account, to be included in the transmission to seller 220. The amount transmitted is preferably an amount equal to the total of the purchase and shipping minus a predetermined percentage retained for facilitating the seller's business. Seller 220 can then use this information to send the appropriate product or service to user 10, while receiving payment for the product or service.

Providing this information to seller 220 will also allow seller 220 to contact user 10 if, for example, a product or service that the user ordered was out of stock, or if shipping was to be delayed, so that the particular situation could be resolved independently of the managers or owners of the system or method of the present invention. Thus, in this embodiment, seller 220 will take responsibility for handling all product satisfaction agreements, warranties, etc. In the case of a product return or cancellation, seller 220 and the user will negotiate the return/cancellation directly, and the user will return the item, as directed, to seller 220. When seller 220 receives the item and wishes to apply credit to user 10, the appropriate funds are transferred from seller 220 to the manager of the secure server system and method (minus any restocking charges, etc.), and seller 220 will contact the manager, such as by e-mail, to detail the purchase and return transaction.

Where seller 220 and user 10 have communicated and agreed that user 10 will return the product or service provided by seller 220, the return transactions may be placed in a queue in the third server 200. Then, the relevant information for returns is recorded on second storage device 210, and the information is transferred to first server 60, either by physical removal of second storage device 210 from third server 200 and physical connection of second storage device 210 to first server 60, or via a physical switch, such as described above. First server 60 then processes the returns and records relevant information that is not fraud-sensitive on first storage device 100. First server 60 also communicates with private receiving network 120 to credit the account of user 10 for the return.

Also, at some point after the processing at first server 60 of the information that first storage device 100 and second storage device 210 contain, information regarding purchases, status, and returns, are stored on first storage device 100. Then this information is transferred to second server 90, either by physical removal of first storage device 100 from first server 60 and physical connection of second storage device 100 to second server 90, or via a physical switch, such as described above. Second server 90 may then communicate with user 10 through public network 80 to provide details of the status of the order, execution of the purchase order, and information regarding returns, such as a crediting of the account associated with the payment information of user 10. Second server 90 may also generate an e-mail for each processed transaction or return to inform the user that the appropriate funds have been charged and credited.

The embodiment comprising three servers may also employ multiple users, such as described above with respect to another embodiment, by allowing multiple users to register and make purchases such as described with respect to user 10.

The embodiment comprising three servers may also employ multiple sellers, such as described above with respect to another embodiment, by allowing multiple sellers to register and execute purchases such as described with respect to seller 220.

In another preferred embodiment, the system and method of the present invention may interact with multiple user interfaces in accordance with the principles of the present invention. Advantageously, the system and method of the present invention may interact with user interfaces that have one or more different parameters, such as different programming languages or communication protocols, written or spoken languages, cultural parameters (e.g. language content or product selection based upon acceptable standards or practices of a particular culture, such as prevalent religions or popular sports), and branding of the user interfaces. For example, the system and method of the present invention advantageously may interact with an American user employing a wireless network interface that employs written English commands, while simultaneously interacting with a Mexican user employing a WWW interface that employs written Spanish commands.

Preferably, this embodiment will employ multiple system administrators 50 that speak different languages so that registration can be made in different languages by phone call or mail. For example, if a call is made by a Spanish-speaking user 10 to register with the system of the present invention, the call may be routed, by a method known in the art, to a system administrator 50 who can communicate in Spanish. In another embodiment, a voice-automated system, or other secure communication system not involving transmission over a public network and having the ability to interact with users speaking different languages, may be employed.

Referring to FIG. 7, a preferred secure server system for interacting with multiple users employing multiple user terminals is shown. Note that the three user terminals 70 and three interface servers 300 are shown only by way of example, and the system and method of the present invention may employ any number of user terminals 70 and interface servers 300 to allow interaction with a desired number and type of user interfaces. In this embodiment, any of the systems and methods such as described with respect to FIGS. 1-6 may be implemented, except that here second server 90 interacts with first server 60 after receiving uniformly formatted purchase information from the interface servers 300.

In this embodiment, each of users 10 will employ a user terminal 70 having particular parameters. Preferably, the user terminal 70 of each user 10 will interact with the interface server 300 that is configured and programmed to communicate with that user terminal 70. For example, a user 10 employing user terminal 70, a wireless device using written English commands and the Wireless Application Protocol (WAP), will access the interface server 300 that is configured and programmed to communicate with user terminals employing such parameters. But this embodiment need not employ multiple interface servers 300, rather, if desired, it may employ multiple programs on one interface server 300, where each program may interact with a different user interface. Each of users 10 will search and browse the user interface, and provide purchase information where a purchase is desired, such as described with respect to the embodiments above. Preferably, one of the processes described above for confirming the identity of each user 10 will be employed, although the confirmation process here will be completed via communication between the compatible interface server 300 and user terminal 70 (whereas the embodiments described above completed the confirmation process via communication between second server 90 and user terminal 70).

After the interface server 300 has received the purchase information from user terminal 70 of a user 10, interface server 300 will employ a program as known in the art, capable of formatting and organizing the purchase information. Advantageously, the program will be capable of formatting and organizing the purchase information or other useful information uniformly, so that this information will be capable, after format and organization, of being queued and processed further by a database management program employed by second server 90. Thus, all information transmitted from an interface 300 to second server 90 can be consistently and interchangeably processed by second server 90. Preferably, as described in embodiments above, all servers other than interface server 300 in this embodiment will employ a common database management program. Advantageously, the formatting and organizing program of each interface server 300 will be programmed to process the purchase information received into identical format to facilitate further processing.

After interface server 300 formats and organizes the purchase information that it has received, it transmits the information through a network, which may be public or private, to second server 90 for further processing. Since all purchase information received by second server 90 will have been formatted and organized by an interface server 300 for further processing by second server 90, second server 90 may aggregate the purchase information sent from all interface servers 300 and process it in organized form, as described with respect to the other embodiments above. Second server 90 may then interact with first server 60. If desired, the third server 200 may be also employed and interacted with as described above. In this embodiment, information that is transmitted back to user terminal 70 of a user 10 must be transmitted through the interface server 300 to which the user terminal 70 has been interacting. Thus, for example, in order to transmit the status of the order, as described above, to user terminal 70, the information must be translated by interface server 300 from the format used by second server 90 to a format that user terminal 70 can process. This translation may be completed by the formatting and organizing program of interface server 300, similar to the process of originally formatting the purchase information received from compatible user terminal 70.

At some point preceding or during the shopping process, such as when a user 10 initially selects a product or service to purchase, interface server 300 determines if user 10 has registered with first server 60, as described above. In this embodiment however, this information will have to be reprocessed by interface server 300 before transmission to compatible user terminal 70, as described in the paragraph above.

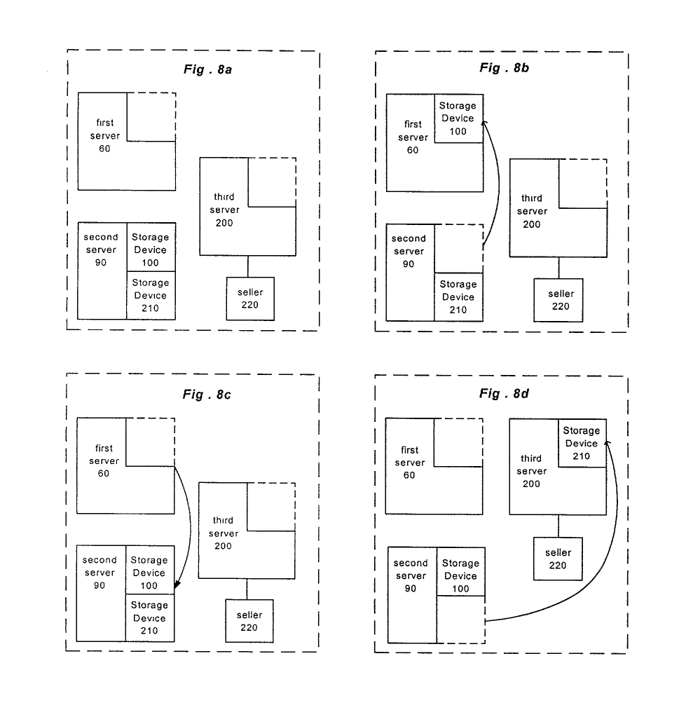

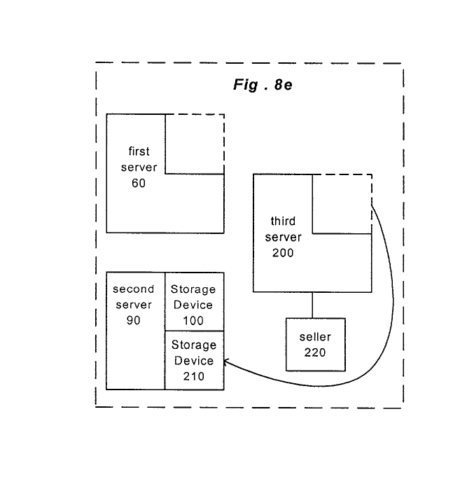

In the embodiments described above that involve third server 200, the interaction between first storage device 100 and second storage device 210 and first server 60, second server 90, and third server 200 may be altered. FIG. 8 shows one way of altering the interaction and associated configuration. Here, storage device 210 will be transferred only between second server 90 and third server 200, and thus will never be maintained on first server 60, which contains the fraud-sensitive data. In this embodiment, all the data that was stored on storage devices 100 and 210 while they were connected to first server 60 will now be stored on storage device 100. Therefore, both order status information (and other order information that is not fraud-sensitive) and seller management information, as described above, will be stored on storage device 100 while it is connected with first server 60. After this information is stored, storage device 100 is transferred back to second server 90, as described in the embodiments above. This information may then be employed by second server 90, and a portion of this information, such as the seller management information, may be loaded onto and stored on storage device 210, which is connected at this point to second server 90. Storage device 210 is then transferred to third server 200 for further processing and use in communication with seller 220, as described above. After this interaction and storage of information (such as information regarding returns), as described above, storage device 210 is transferred back to second server 90. Second server 90 may then process the information from storage device 210 and communicate this information to user 10, as described above. Other information, including status of the order and execution of the order, will still be communicated between user 10 and second server 90. In this embodiment, the user may obtain information regarding the status of the order and execution of the order while the system of the present invention is communicating with the seller.

In another alteration to the embodiments involving third server 200, the alteration and associated configuration will be as described above and shown in FIG. 8, except that the transfer of information between second server 90 and third server 200 may be accomplished via a network, which may be public or private. Thus, storage device 210 will not be included here, since information obtained by second server 90 from an interface server 300 or first server 60 via storage device 100 may be transmitted to the third server 200 via the public or private connection. A public or private connection may be used since no fraud-sensitive information is included on either second server 90 or third server 200.

Note that in the embodiments described above that allow interaction with multiple user interfaces, it is not critical that multiple interface servers 300 be employed. Instead, multiple programs or program segments may be employed on one interface server 300, where each program or program segment may interact with a different user interface, if desired.

In another preferred embodiment, fraud-sensitive data including medical records are managed. In this implementation, the medical records have been generated within the company or enterprise that is operating the secure server system, such as a hospital that has created and retained medical records of its patients. Thus, the step of transmitting the medical records by offline transmission method 40 is unnecessary. Instead, system administrator 50 simply accesses the medical records at the company or enterprise and inputs them into first server 60. If the medical records do not already exist at the company or enterprise, the medical records may still be input into first server 60 by system administrator 50 after being transmitted by user 10 or a company or business by offline transmission method 40, such as by the methods described with reference to the preferred embodiments above. Information not including the fraud-sensitive information, but including information identifying user 10, is also obtained and input and stored on first server 60 and second server 90 so that second server 90 will have information identifying users that registered with first server 60.

Once the medical records have been input into first server 60, user 10 accesses and employs user terminal 70 to connect to second server 90 including first storage device 100 through public network 80, such as the Internet, as described above. In this embodiment, user 10 accesses a user interface on second server 90 through a custom-branded application, or web browser. The user interface includes an access area in which user 10 inputs information sufficient to identify himself or herself. Once this identification has been submitted, the identification of the requester is preferably confirmed via an exchange of e-mails as described with reference to the preferred embodiments described above. Once the identification has been confirmed, as described above with reference to other preferred embodiments, second server 90 employs a common database management program, capable of running on both second server 90 and first server 60, to process the information in organized form. Second server 90 then stores the user's information regarding a particular transaction, such as the identification of registered user 10 placed in organized form by the database management program, in first storage device 100. Then, the user information is transferred to first server 60, either by physically detaching first storage device 100 from second server 90 and physically transferring it to first server 60, where storage device 100 is attached to first server 60, or via a physical switch, such as described above.

Once first storage device 100 has been attached to first server 60, first server 60 processes the information of user 10 as organized by the database management program along with the medical records data contained on first server 60 that corresponds to user 10. Preferably, first server 60 also employs the database management program to organize the medical records data so that the information of user 10 regarding the particular transaction on first storage device 100 can be automatically matched and processed with the medical records of user 10 by the database management program, to determine order information, which includes the medical records of user 10. In this implementation the order information is preferably sent to user 10 via an offline transmission method, such as via United States mail. However, the order information may also be sent via a secure method such as public-key encryption, as described above. Preferably, first server 60 encrypts the medical records and stores the encrypted data onto first storage device 100. The encrypted data is then transferred to second server, either by physically detaching first storage device 100 from first server 60 and physically moving it back to second server 90, where it is reattached, or via a physical switch, such as described above. At this point, second server 90 may communicate with user 10 through public network 80 to provide the encrypted medical records to user 10 along with any details of the execution of the order. If user 10 did not have medical records, did not have access to them, they were not yet contained on first server 60, or the order was otherwise unfulfilled, second server 90 may also communicate the details of the status of the order, and/or execution of the purchase order. This process may be repeated once more requests for medical records have been placed by user 10.

In an implementation involving multiple users, a user may desire access to the medical records of another user or users, such as where an insurance company desires to access medical records of one or more of its customers. In this implementation, each user desiring access to medical records other than his or her own must obtain authorization. Authorization is preferably obtained by the user by communicating with system administrator 50 or a customer service representative, and providing necessary authorization information as provided by law or otherwise known in the art for accessing others' medical records. System administrator 50 or a customer service representative then inputs data associated with this information into first server 60 and second server 90. The data may include an authorization number or e-mail address that identifies the user along with identification of others for which the user has access to medical records. As in the embodiment above, the user accesses the user interface and inputs information sufficient to identify himself or herself, and also inputs authorization information via a secure method known in the art and preferably has the identification and authorization confirmed via an exchange of e-mails as described with reference to preferred embodiments described above. After confirmation of the user identification and authorization, this information is stored on first storage device 100, which is transferred to first server 60 for processing, as described above in the multiple embodiments. Thus, the information of the user regarding the particular transaction on first storage device 100 can be automatically matched and processed with the medical records requested and identification and authorization information of the user by the database management program, to determine order information, which includes the requested medical records that the user is authorized to receive. In this implementation as above, the order information is preferably sent to user 10 via an offline transmission method, such as via United States mail. However, the order information may also be sent via a secure method such as a method involving public key encryption, as described above. Thus, first server 60 may encrypt the medical records and store the encrypted data onto first storage device 100. The encrypted data may then be transferred to second server 90, either by detaching first storage device 100 from first server 60 and physically moving it back to second server 90, where it is reattached, or via a physical switch, such as described above. At this point, second server 90 may communicate with the user through public network 80 to provide the encrypted medical records to the user along with any details of the execution of the order. If some or all of the medical records requested did not exist, the user did not have access to them, they were not yet contained on first server 60, or the order was otherwise partially or fully unfulfilled, second server 90 may also communicate the details of the status of the order. This process may be repeated once more requests for medical records have been placed by the user.

The medical records embodiments of the secure server system and method may also employ three servers and two storage devices such as described above. In either the two or three server system or method, where the operator or owner of the secure server system desires to charge for access to the medical records, the operator or owner may require transmission of payment information by the user to first server 60 during the registration process, with subsequent transmission of this payment information to a credit card company via a nonpublic communications method 110 when medical records are requested by the user, such as implemented in the non-medical device implementations.

The medical records embodiments of the secure server system and method may also employ one or more interface servers as described in embodiments above.

Note that in the preferred embodiments listed above, it is not critical that the identification or authorization information, or other information not including fraud-sensitive data, be originally transmitted onto first server 60. Instead, this information may be transmitted by a user to second server 90 via a public network connection, as described above.

While the foregoing description and drawings represent the preferred embodiments of the present invention, it will be understood that various additions, modifications, and substitutions may be made without departing from the spirit and scope of the present invention as defined in the accompanying claims. In particular, it will be clear to those skilled in the art that the present invention may be embodied in other specific applications, methods, forms, structures, arrangements, proportions, and with other elements, materials, and components, without departing from the spirit or essential characteristics of the invention. It will be appreciated that features described with respect to one embodiment typically may be applied to another embodiment, whether or not explicitly indicated. The various features described may be used singly or in any combination. The presently disclosed embodiments are therefore to be considered in all respects as illustrative and not restrictive, the scope of the invention being indicated by the appended claims, and not limited to the foregoing description.

What is claimed is:

1. A method of securely obtaining and maintaining fraud-sensitive data while using the fraud-sensitive data to complete transactions, comprising:
receiving fraud-sensitive data from user by telephone or United States mail;
inputting and storing the fraud-sensitive data in a first server that is unconnected to any public network;
providing access, to users employing user terminals having different parameters, to a system site on a public network via different user interfaces;
completing a transaction, except for payment, with the user by: employing one or more interface servers configured and programmed to communicate with and obtain the purchase information from the user terminals to organize the purchase information so that it may be processed by a second server; transmitting the organized purchase information to the second server; and maintaining purchase information input by the user on a first storage device connected to the second server;
verifying the identification of the user;
transferring the purchase information maintained on the first storage device on the second server to the first server without electrically connecting the first server to the second server;
processing the purchase information in the first server along with the fraud-sensitive data that corresponds to the purchase information to determine charging information;
connecting the first server to a private receiving network via a nonpublic communications method; and
transmitting the charging information to the private receiving network via the nonpublic communications method to complete the purchase transaction.

2. The method as in claim 1, wherein the transferring of the information maintained on the storage device on the second server to the first server without electrically connecting the first server and the second server comprises:
detaching the first storage device from the second server and attaching the first storage device in the first server; and
inputting the purchase information in the first server from the first storage device into the first server.

3. The method as in claim 1, wherein the transferring of the information maintained on the storage device on the second server to the first server without electrically connecting the first server and the second server comprises:
operating a physical switch to drop a connection between the second server and first storage device and make a connection between the first server and the first storage device.

4. The method as in claim 1, further comprising disconnecting the first server from the private communications network after completion of the purchase transaction.

5. The method as in claim 1, wherein the first server is only connected to the private receiving network while the charging information is being transmitted.

6. The method as in claim 1, wherein the fraud-sensitive data comprises a payment card number.

7. A method of securely maintaining information while using the information to complete a transaction, comprising:
storing fraud-sensitive data of a user on a first server that is unconnected to any public network;
providing access, to users employing user terminals having different parameters, to a system site on a public network via different user interfaces;
completing a transaction, except for payment, with the user by: employing one or more interface servers configured and programmed to communicate with and obtain the information from the user terminals to organize the information so that it may be processed by a second server that is connected to the public network; transmitting the organized information to the second server; and maintaining the organized information input by the user on a first storage device connected to the second server;
transferring the organized information maintained on the first storage device on the second server to the first server without electrically connecting the first server to the second server;
processing the organized information along with fraud-sensitive data of the user to determine charging information; and
transmitting the charging information to a private receiving network via a nonpublic communications method.

8. The method of claim 7, wherein the transferring of the organized information maintained on the first storage device on the second server to the first server without electrically connecting the first server to the second server comprises:
detaching the first storage device from the second system and attaching the first storage device to the first server.

9. The method of claim 7, wherein the transferring of the information maintained on the first storage device on the second server to the first server without electrically connecting the first server to the second server comprises:
operating a physical switch to drop a connection between the second server and first storage device and make a connection between the first server and the first storage device.

10. The method as in claim 9, further comprising disconnecting the first server from the private communications network after transmitting the charging information to the private receiving network.

11. The method as in claim 7, wherein the first server is only connected to the private receiving network while the charging information is being transmitted.

12. The method as in claim 10, wherein the fraud-sensitive data comprises a payment card number.

13. The method as in claim 10, wherein the fraud-sensitive data is received from a user through an offline transmission method.

14. The method as in claim 13, wherein the offline transmission method comprises the use of either telephone or United States mail.

15. The method as in claim 10, wherein the fraud-sensitive data is received from a user via an offline transmission method prior to the storing of the fraud-sensitive data.

16. The method as in claim 7, wherein the identification of the user is verified prior to transmitting the charging information to the private receiving network.

17. The method as in claim 16, wherein the identification of the user is verified by a method involving public-key encryption.

18. A system for securely maintaining information while using the information to complete a transaction, comprising a computer program embodied in a computer-readable medium and configured to:
store fraud-sensitive data of a user on a first server that is unconnected to any public network;
provide access, to users employing user terminals having different parameters, to a system site on a public network via different user interfaces;
complete a transaction, except for payment, with the user by: employing one or more interface servers configured and programmed to communicate with and obtain the information from the user terminals to organize the information so that it may be processed by a second server that is connected to the public network; transmitting the organized information to the second server; and maintaining the organized information input by the user on a first storage device connected to the second server;
transfer the information maintained on the first storage device on the second server to the first server without electrically connecting the first server to the second server;
process the user's information along with fraud-sensitive data of the user to determine charging information; and
transmit the charging information to a private receiving network via a nonpublic communications method.

19. The system as in claim 18, wherein the transfer of the information maintained on the first storage device on the second server to the first server without electrically connecting the first server to the second server comprises:
the detachment of the first storage device from the second server and the connection of the first storage device to the first server.

20. The system as in claim 18, wherein the transfer of the information maintained on the first storage device on the second server to the first server without electrically connecting the first server to the second server comprises:
the operation of a physical switch to drop a connection between the second server and first storage device and make a connection between the first server and the first storage device.

21. The system as in claim 20, wherein the computer program embodied in a computer-readable medium is further configured to disconnect the first server from the private communications network after transmitting the charging information to a private receiving network.

22. The method as in claim 21, wherein the wherein the first server is only connected to the private receiving network while the charging information is being transmitted.

23. A system for securely maintaining information while using the information to complete a transaction, comprising:
means for storing fraud-sensitive data of a user on a first server that is unconnected to any public network;
means for providing access, to users employing user terminals having different parameters, to a system site on a public network via different user interfaces;
means for completing a transaction, except for payment, with the user by: employing one or more interface servers configured and programmed to communicate with and obtain the information from the user terminals to organize the information so that it may be processed by a second server that is connected to the public network; and transmitting the organized information to the second server; and maintaining the organized information input by the user on a first storage device connected to the second server;
means for transferring the information maintained on the first storage device on the second server to the first server without electrically connecting the first server to the second server;
means for processing the user's information along with fraud-sensitive data of the user to determine charging information; and
means for transmitting the charging information along with the fraud-sensitive data to a private receiving network via a nonpublic communications method to complete the particular transaction.

24. A method of securely maintaining information while using the information to complete a transaction, comprising:
storing fraud-sensitive data on a first server that is unconnected to any public network;
providing access, to users employing user terminals having different parameters, to a system site on a public network via different user interfaces;
completing a transaction, except for payment, with the user by: employing one or more interface servers configured and programmed to communicate with and obtain the information from the user terminals to organize the information so that it may be processed by a second server that is connected to the public network; transmitting the organized information to the second server; and maintaining the organized information input by the user on a first storage device connected to the second server;
transferring the information maintained on the first storage device on the second server to the first server without electrically connecting the first server to the second server;
processing the user's information along with fraud-sensitive data of the user to determine order information; and
transmitting the order information to the user.

25. The method of claim 24, wherein the transferring of the information maintained on the first storage device on the second server to the first server without electrically connecting the first server to the second server comprises:
detaching the first storage device from the second system and attaching the first storage device to the first server.

26. The method of claim 24, wherein the fraud-sensitive information comprises medical records.

27. The method of claim 24, wherein the order information is encrypted before being transmitted to the user.
